(19) United States
(12) Patent Application Publication
(10) Pub. No.: US 2019/0145134 A1
(43) Pub. Date: May 16, 2019

(54) DOOR HANDLE MODULE FOR A MOTOR VEHICLE

(71) Applicant: Huf Hülsbeck & Fürst GmbH & Co. KG, Velbert (DE)

(72) Inventors: Matthias Löw, Ratingen (DE); Willi Put, Winterswijk Meddo (NL)

(21) Appl. No.: 16/306,930

(22) PCT Filed: Apr. 26, 2017
(86) PCT No.: PCT/EP2017/059968

§ 371 Date: Dec. 4, 2018

(30) Foreign Application Priority Data
Jun. 10, 2016 (DE) 10 2016 110 720.4

(51) Int. Cl. E05B 79/06; E05B 85/10; E05B 85/06

(52) U.S. Cl. CPC E05B 79/06; E05B 85/103; E05B 81/90; E05B 85/06; E05Y 2900/531; E05B 85/107

(57) ABSTRACT

A door handle module for a motor vehicle includes at least a handle unit comprising a handle housing and a trim. The handle unit is designed to be movable relative to a door of the motor vehicle at least between a resting position and an operating position. The trim is arranged at least substantially flush with an outside of the door in the resting position. The trim can be connected to the handle housing by means of at least two interlocking connections.

### FIELD

The invention relates to a door handle model for a motor vehicle, having at least a support and a handle unit comprising a handle housing and a trim, wherein the handle unit is designed to be movable relative to a door of a motor vehicle between a resting position and an operating position, and the trim is arranged at least substantially flush with an outside of the door in the resting position, wherein the trim can be connected to the handle housing by means of at least two interlocking connections.

### BACKGROUND

This section provides background information related to the present disclosure and is not necessarily prior art.

A door handle module for a motor vehicle is known from the prior art, which includes a support and a handle unit that is arranged to be flush to the surface of a door of the motor vehicle while in the resting position. The handle unit has a handle housing, which is provided with a trim. This trim is connected with the handle housing via a clip-on connection and a screw connection. Initially, during assembly, the trim must be clipped to the housing; when this is completed, the trim is screwed onto the handle housing with a screw. Thereby a worker must carry out two assembly steps in order to assemble and disassemble the trim on the handle housing.

### SUMMARY

It is the object of the present invention to provide a door handle module in which the assembly and disassembly of the trim is simplified.

The object is solved by the characterizing portion of patent claim 1, wherein, during assembly of the trim, a first interlocking connection between the handle housing and the trim can be manufactured simultaneously, which secures the trim to the handle housing in the horizontal direction Q, and a second interlocking connection which secures the trim to the handle housing in the longitudinal direction L, wherein an uninterrupted disassembly of the trim in the horizontal direction Q can be accomplished only by loosening the second interlocking connection, wherein loosening of the first interlocking connection can only be accomplished after loosening the second interlocking connection.

The invention significantly simplifies the assembly of the trim. This is particularly very advantageous during initial assembly of the trim in the factory as well for repairs in a workshop. A worker must simply fasten the trim to the handle housing in the horizontal direction Q. This first interlocking connection connects the trim immediately with the handle housing in the horizontal direction Q of the handle housing. During the assembly of the trim, a second interlocking connection is created between the trim and the handle housing, which secures the trim in the longitudinal direction L of the handle housing. Thereby the trim is connected firmly, safely, and rattle-free to the handle housing. For example, to exchange an electronic unit that is arranged in the handle housing, a worker must simply loosen the second interlocking connection. Then the worker can move the trim in the longitudinal direction L and remove the trim. The first interlocking connection between the trim and the handle housing is loosened at the time of loosening or during the loosening of the trim from the handle housing. This simple assembly and disassembly of the trim from the handle housing saves time and thereby reduces the costs of assembly and disassembly. The door handle module can be fastened securely and rattle-free to a door or movable lid of the motor vehicle if the door handle module has a support. The door has an assembly opening that serves to receive the support. Here, the support having the handle unit is inserted through the assembly opening. Preferably, the handle unit is then not yet provided with the trim in order to prevent scratching any paint layer arranged on the trim. If the support is fastened inside the door, the handle unit can be provided with the trim later. In doing so, it is possible that the handle unit is found in a position spaced apart from the door, in particular in the operating position. In this way, a simple and secure mounting of the trim to the handle unit is assured without damaging the trim.

According to a preferred embodiment of the door handle module, it can be provided that the handle unit has a recess or an opening, in which an object, in particular the shaft of a key, can be inserted in order to loosen the second interlocking connection between the trim and the handle housing. This has the advantage of making the trim to be easily disassembled. Only one object is necessary to loosen the trim from the handle housing. In particular, in the use of a motor vehicle key, the shaft of the key of the motor vehicle key can be inserted into the opening or recess in order to loosen the trim from the handle housing. In doing so, preferably the recess or opening essentially has the dimensions of the cross-section of the shaft of the key. Thus, for example the opening or recess can be minimally larger than the cross-section of the shaft of the key. In this case the shaft of the key can essentially be inserted into the recess or opening without any play.

The shaft of the key then serves as a quasi-lever to loosen the second interlocking connection.

The construction of the door handle module can be designed very simply and compactly if the opening or recess is arranged on the handle housing.

According to another preferred embodiment of the door handle module, it can be provided that the opening or recess opens into a guide channel that is arranged at least partially within the handle housing. Using the guide channel, the object, in particular the shaft of the key, can be inserted simply and securely into the opening or recess. Tilting of the object, in particular the shaft of the key, in the opening or recess is thereby excluded. Since the guide channel can be arranged within the handle housing, when grasping the handle unit, impaired haptic in pulling the handle unit by a user is prevented. The user can activate the handle unit undisturbed without coming into contact with the guide channel.

According to another preferred embodiment of the door handle module, it can be provided that the opening or recess in the resting position is arranged within the support invisible from the outside. During opening, the handle unit is moved mechanically, electrically, or electromechanically into the operating position. During travel and during parking of the motor vehicle, the handle unit is in the resting position, wherein the trim of the handle unit is arranged essentially flush to the outer covering of the motor vehicle door. Then, the recess or opening is also arranged in a protected fashion, so that, advantageously, penetration of dirt or moisture into the handle housing is limited or even completely prevented. In addition, the opening or recess can be provided with a rubber lip that closes the opening or recess, and that opens only when operating the object, in particular the shaft of the key. The rubber lip therefore serves as protection against moisture and dirt, which otherwise might penetrate into the handle housing through the opening or recess.

Simple assembly and disassembly of the trim from the handle housing can be accomplished simply if loosening the second interlocking connection between the trim and the handle housing is achievable only in the operating position and/or in an intermediate position, where the handle unit lies between a resting position and an operating position.

The construction of the door handle module can be done very economically and simply if the first interlocking connection between the trim and the handle housing is designed with at least one locking connection.

The construction of the door handle module can be further simplified if the locking connection is designed with at least one locking element arranged in particular in an L shape and with at least one counterlocking element arranged on the handle housing, wherein the locking element is arranged behind the counterlocking element in the assembled state of the trim in order to prevent horizontal movement of the trim. This advantageous embodiment of the door handle module prevents the trim from falling off or rattling, even during heavy vibrations during the movement of the motor vehicle.

According to another preferred embodiment of the door handle module, it can be provided that the locking connection is designed further as an undercut connection, wherein, in the assembled state of the trim, the locking element arranged on the trim is connected with a undercut recess arranged at the handle housing, in particular in an L shape. The first interlocking connection is secured based on the undercut recess, which secures the trim to the handle housing in the horizontal direction Q. Based on the particularly L shaped undercut recess, during disassembly of the trim from the handle housing, the trim can be loosened from the handle housing simply and securely. An additional loosening of the locking connection in the horizontal direction Q of the handle housing can preferentially be dispensed with, with the result that the trim during disassembly must be moved in the longitudinal direction L of the handle housing, and thereupon can be removed without resistance and without undoing an interlocking connection in the horizontal direction Q. The particularly L shaped undercut then serves during disassembly of the trim from the handle housing as a guide for the locking element arranged on the trim, which preferentially is also L-shaped.

According to another preferred embodiment of the door handle module, it can be provided that the undercut recess, in particular a wall partition of the undercut recess, is at least partially formed by the counterlocking element. The wall partition advantageously serves to create the locking connection and can also serve as a guide for the locking connection during disassembly of the trim from the handle housing.

The disassembly of the trim from the handle housing can be accomplished simply if the second interlocking connection between the trim and the handle housing is designed with at least one clip connection. The clip connection can be loosened simply and securely by inserting the object into the opening or recess of the handle housing. In this way, for example the shaft of the key of the motor vehicle key can be used to loosen the clip connection.

In order to store the trim on the handle housing without any rattling and at the same time to assure a simple and secure disassembly of the trim from the handle housing without damaging the trim from the outside, it can be further provided that the clip connection be made by a projecting element arranged on the trim and by a movable elastic clip arranged on the handle housing, wherein in the assembled state of the trim at the handle housing, the clip contacts the projecting element to secure the trim in longitudinal direction L. The manufacturing costs can be reduced if the projecting element is designed as one piece with the trim. In this way, the trim and the projecting element can preferentially be made from the same synthetic material. It is also suggested that the trim with the projecting element arranged on it be formed as an injection molding part. The second interlocking connection between the trim and the handle housing can afterwards be completed several times if the clip is designed to be elastic and preferably is made of plastic. The tongue of the projecting element serves as a contact surface for the object inserted through the opening or recess, in particular for the shaft of the key.

The clip connection can be designed securely and robustly if the elastically movable clip is designed as an L-shaped tongue.

The L-shaped tongue can serve as a stop for the projecting element if a tongue projecting element is arranged on the L-shaped tongue, which is arranged opposite the opening or recess, in particular opposite the guide channel.

The second interlocking connection between the trim and the handle housing can be simply and securely loosened during disassembly of the trim from the handle housing if, upon insertion of the object, the elastic clip is designed to be movable in order to loosen the second interlocking connection, in particular the contact between the projecting element and the clip.

An even more secure and rattle-free connection of the trim with the handle housing can be assured if the trim and the handle housing can be connected by a third interlocking connection, wherein the third interlocking connection is designed as a rib-groove connection, which is arranged by means of at least one groove, which is arranged on the trim, and by at least one rib, which is arranged on the handle housing, or which is arranged by means of at least one rib element, which is arranged on the trim, and by at least one groove, which is arranged on the handle housing. The trim and the handle housing may, as early as the manufacturing process, be provided simply and economically with one or several grooves or with one or several ribs, in particular in the case where the trim and the handle housing are made of plastic.

According to another preferred embodiment of the door handle module, it can be provided that during the assembly of the trim, the first interlocking connection and the third interlocking connection can be made between the handle housing and the trim, which also secures the trim in the longitudinal direction L. In this fashion the time for assembly of the trim on the handle housing can be significantly reduced; in addition, the connection between the trim and the handle housing is made even more secure.

According to another preferred embodiment of the door handle module, it can be provided that an uninterrupted disassembly of the trim can be performed only by loosening the second interlocking connection, wherein loosening of the third interlocking connection is possible only after loosening the second interlocking connection. This arrangement takes care of a rattle-free arrangement of the trim on the handle housing. The third interlocking connection can be loosened only by intentional handling, that is, through loosening the second interlocking connection.

User comfort may be increased if a functional component, in particular a locking cylinder, is arranged within the support and behind the handle unit, in particular behind the handle housing. When the handle unit is in the resting position, the functioning part is protected from external environmental influences.

The invention will be described in more detail on the basis of an exemplary embodiment.

### DESCRIPTION OF DRAWINGS

The drawings show:

FIG. 1 A door handle module having a handle unit with a trim in a resting position,

FIG. 2 The door handle module in an operating position in an oblique view from below,

FIG. 3 The door handle module in the operating position in an oblique view from above,

FIG. 4 The trim in a view from behind,

FIG. 5 A section of the trim in the view from behind,

FIG. 6 A section of a handle housing of the door handle module in a perspective view,

FIG. 7 A section of the handle housing with a rear recess in a view from above,

FIG. 8 A section of the handle housing with a rib element in a perspective view,

FIG. 9 A section of the handle unit of the door handle module during disassembly of the trim in a view from behind,

FIG. 10 A section of the handle unit of the door handle module according to a section A-A in FIG. 9,

FIG. 11 The handle unit of the door handle module during disassembly of the trim in an oblique view from below,

FIG. 12 A section of the handle unit of the door handle module after disassembly of the trim in a perspective view from the front, and

FIG. 13 A section of the handle unit showing a stem-groove connection.

### DETAILED DESCRIPTION

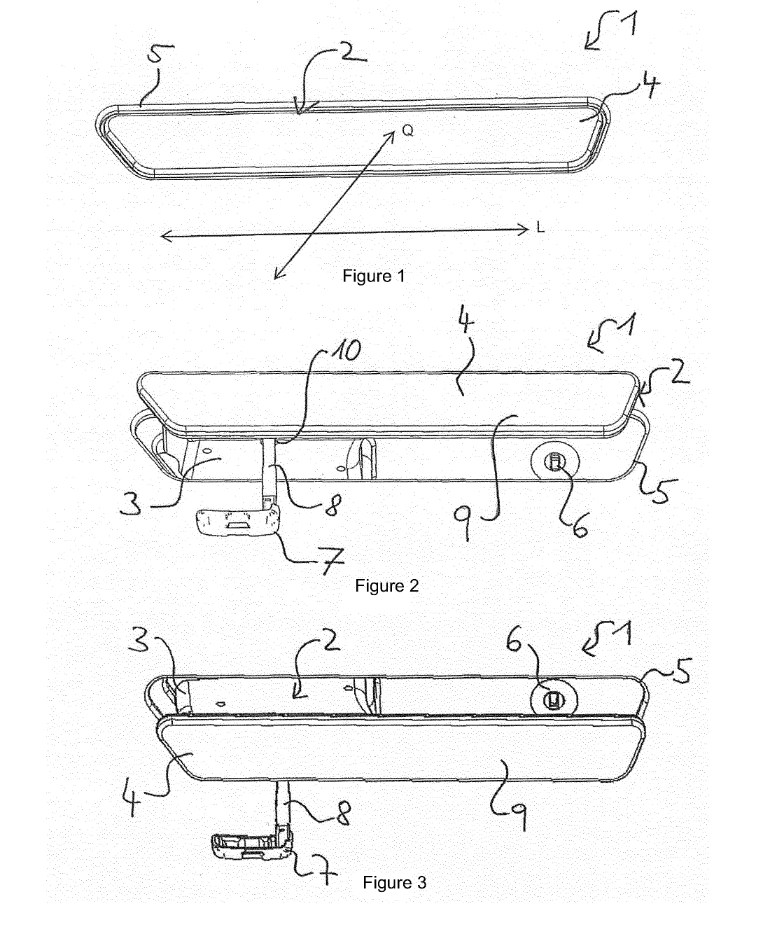

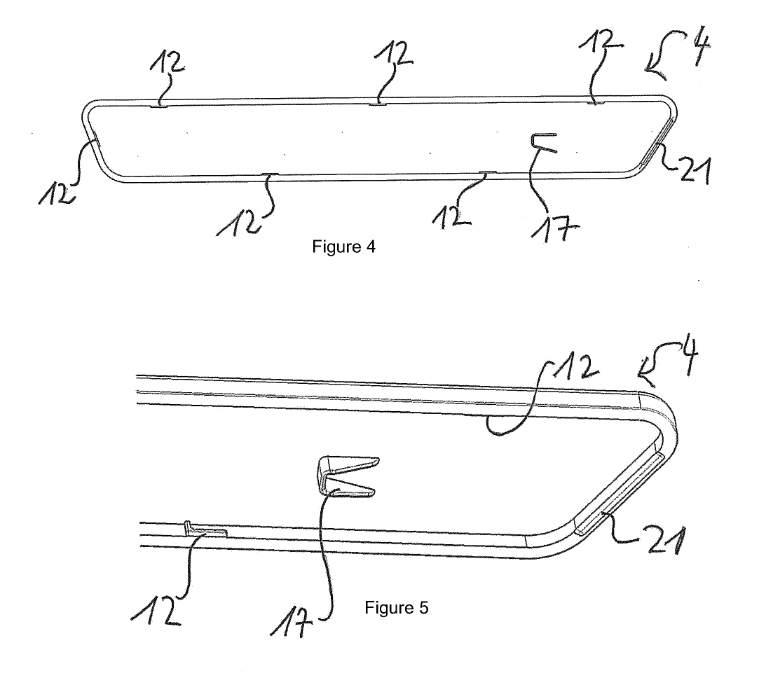

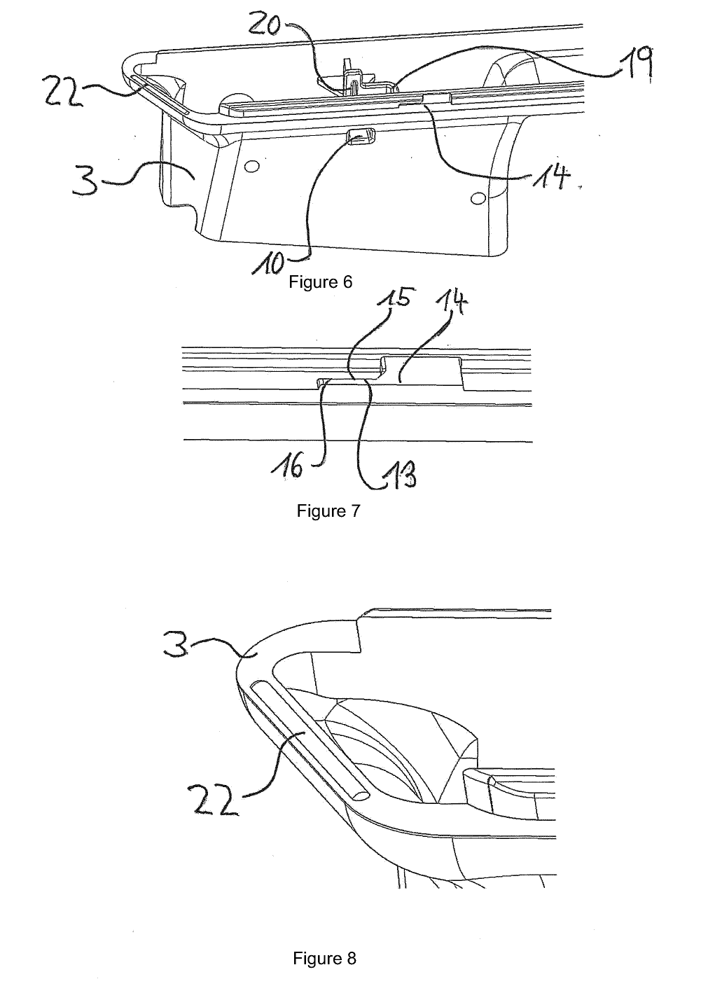

FIG. 1 shows a door handle module 1 according to the invention for a motor vehicle in a resting position, which can be arranged on a door of the motor vehicle, in particular a side door, and/or alternatively on a hinged lid, in particular a tailgate. The door handle module 1 includes a handle unit 2 with a plastic handle housing 3, which for example serves for arrangement of an electronic unit, such as a sensor, and a trim 4 made from plastic, wherein the handle unit 2 is stored as a movable part in a support 5, which can be fastened to the door of the motor vehicle. The support 5 serves to receive a function component, which is designed in the current exemplary embodiment as a locking cylinder 6. As one can readily see in FIGS. 2 and 3, the locking cylinder 6 is arranged inside the support 5 behind the handle unit 2, in particular behind the handle housing 3. The locking cylinder 6 can be used in an emergency, when the electronics made for opening and closing the motor vehicle fail. With the help of an emergency key 7, which includes a key shaft 8, the motor vehicle can then be unlocked and opened.

The handle unit 2 can be moved relative to the door of the motor vehicle between a resting position, shown in FIG. 1, and an operating position, shown in FIG. 3 and FIG. 4, for example by an electric motor and/or a mechanical device. In the resting position, the trim 4 is essentially flush with the outer side of the door, so that during travel the aerodynamic properties of the motor vehicle are improved because of the reduced air resistance. In the operating position, at least one section of the handle unit 2, in particular the trim 4, is arranged spaced apart from the door, so that a user can activate the handle unit 2 to open the door, in particular a handle section 9 of handle unit 2. Thereby the handle unit 2, which revolves around an axis not shown in detail, may activate a door lock that is connected with the handle unit 2 inside the door. Furthermore, the handle unit 2 has an opening 10, or alternatively a recess, in which an object, in particular the shaft of the key 8, may be inserted in order to loosen the second interlocking connection between the trim 4 and the housing 3. In this case, the opening 10 is arranged on the handle housing 3, but it might alternatively at least partially be arranged on the trim 4 as well. The opening 10 opens out into a guide channel 11, which is arranged inside the handle housing 3, wherein the opening 10, in the resting position, is arranged within the support 5 to be invisible from the outside. The guide channel 11 serves to guide the shaft of the key 8.

The trim 4 is, in the present case, connected by a first, second, and third interlocking connection with the handle housing 3 of the door handle module 1. During assembly of the trim 4, at the same time a first interlocking connection is created between the handle housing 3 in the trim 4, a connection is created, that secures the trim 4 opposite the handle housing 3 in the horizontal direction Q, and a second interlocking connection that secures the trim 4 opposite the handle housing 3 in the longitudinal direction L. In addition, during assembly of the trim 4, the first interlocking connection and the third interlocking connection may be created simultaneously between the trim 4 on the handle housing 3, wherein the third interlocking connection additionally secures the trim 4 primarily in the longitudinal direction L opposite the handle housing 3.

Consequently, an uninterrupted disassembly of the trim 4 from the handle housing 3 in the horizontal direction Q can be performed only by loosening the second interlocking connection, wherein loosening of the first interlocking connection can only be performed after loosening the second interlocking connection, wherein loosening of the third interlocking connection can only be performed after the loosening of the second interlocking connection.

Basically, in the present exemplary embodiment, a loosening of the second interlocking connection between the trim 4 on the handle housing 3 is possible only in the operating position and/or in an intermediate position, in which the handle unit 2 lies between a resting position and an operating position.

Below, the three interlocking connections are described in detail.

The first interlocking connection between the trim 4 and the handle housing 3 is designed as a locking connection. The locking connection includes at least one L-shaped locking element 12 arranged on the trim 4, and at least one counterlocking element 13 arranged on the handle housing 3. In the present case, the trim 4 has six locking elements 12, and the handle housing 3 has six counterlocking elements 13, wherein these are arranged circumferentially at the trim 4 or on the trim housing 3. The number of locking elements 12 and counterlocking elements 13 can be increased or reduced as needed, wherein this depends on the materials and the size of the trim 4 and of the handle housing 3. In the assembled state of the trim 4, the locking elements 12 are arranged behind the counterlocking elements 13 in order to prevent horizontal movement of the trim 4 against the handle housing 3. The locking connection, in particular the counterlocking elements 13, are designed as an undercut connection, wherein, in the assembled state of the trim 4, the locking elements 12 arranged on the trim 4 connect with the undercut recess 14 arranged on the handle housing. The undercut recess 14, in particular a wall partition 15 of the undercut recess 14, is formed at least partially by the counterlocking elements 13. During assembly of the trim 4 onto the handle housing 3, the locking elements 12 arranged on the trim 4 will consequently be clipped to the particular locking section 16, in particular to the respective wall partitions 15.

The second interlocking connection between the trim 4 and the handle housing 3 is designed as a clip connection, wherein the opening 10 is arranged in the area of the clip connection.

The clip connection is designed by a protruding element 17 arranged in the trim 4 and an elastic movable clip 18 arranged on the handle housing 3, which is formed as an L-shaped tongue 19. The trim 4 and a protruding element 17 are designed as one piece, in particular as a one-piece molded injection part, and are made of the same material. A tongue protruding element 20 is arranged on the L-shaped tongue 19, which is arranged opposite the opening 10, in particular opposite the guide channel 11.

In the assembled state of the trim 4 at the handle housing 3, the clip 18 contacts the protruding element 17 in order to secure the trim 4 in the longitudinal direction L. For insertion of the shaft of the key 8, the elastic clip 18 is designed to be movable in order to loosen or to remove the second interlocking connection, in particular the contact between the protruding element 17 and the clip 18.

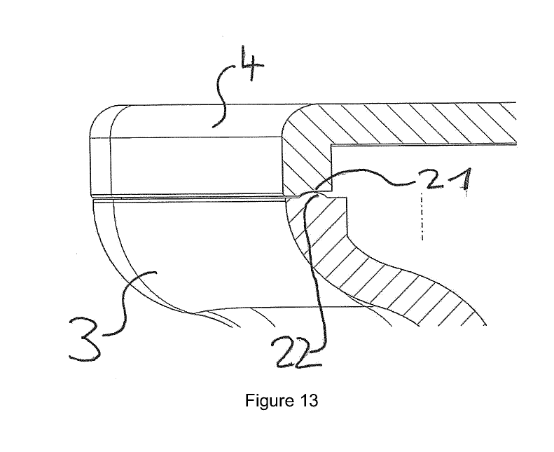

The third interlocking connection between the trim 4 and the handle housing 3 is designed as a rib-groove connection, which is presented and enlarged in FIG. 13. The rib-groove connection is formed through at least one groove 21 arranged on the trim 4 and through at least one rib element 22 arranged on the handle housing 3.

Alternatively, the rib-groove connection is also formed through at least one groove element 22 arranged on the trim 4 and through at least one groove 21 arranged on the handle housing.

Below is described how the assembly of the door handle module 1 takes place, in particular the assembly and disassembly of the trim 4.

During initial assembly of the door handle module 1 in the factory, it is assembled into an opening of the door. In doing so, the door handle module 1 is inserted from behind through the assembly opening into the door and fastened inside the door, for example through at least one screw connection and/or clip connection. In order to prevent scratching of the trim 4, in particular scratching of the paint layer arranged on the trim 4 when inserting the door handle module 1 through the assembly opening of the door, the trim 4 is fastened to the assembly housing 3 only when the support 5 has been fastened within the door 5. The assembly of the trim 4 on the handle housing 3 is possible both in the resting position and in the operating position as well as in the intermediate position, because for fastening of the trim 4 to the handle housing 3 power is exerted only in the horizontal direction Q on the handle housing 3. Subsequently a worker takes the trim 4 into his hand and presses it onto the handle housing 3 in the horizontal direction Q. In doing so, the first, second, and third interlocking connections between the trim 4 and the housing 3 are created simultaneously. As already described above, the trim 4 is secured by the locking elements 12 and the counterlocking elements 13 in the horizontal direction Q. Simultaneously, the protruding element 17 as part of the second interlocking connection, contacts the L-shaped tongue 19 and secures the trim 4 in the longitudinal direction L.

In order to further strengthen the firmness against movement of the trim 4 against the handle housing 3 in the longitudinal direction L, the rib element 22 arranged on the trim 4 engages with the groove 21 arranged on the handle housing 3, wherein the rib element 22 and the groove 21 form an interlocking pressure connection.

As a result, the trim 4 is connected securely, rattle-free, and firmly with the handle housing 3, so that even during movement of the motor vehicle, the trim 4 is prevented from falling off the handle housing 3.

During the life of the motor vehicle, it may occur that a disassembly the trim 4 is required, because for example an electronic unit arranged within the handle housing 3 fails and must be exchanged, or the trim 4 has scratches on the paint layer and should be replaced on aesthetic grounds.

In both examples, removal of the trim 4 from the handle housing 3 is necessary.

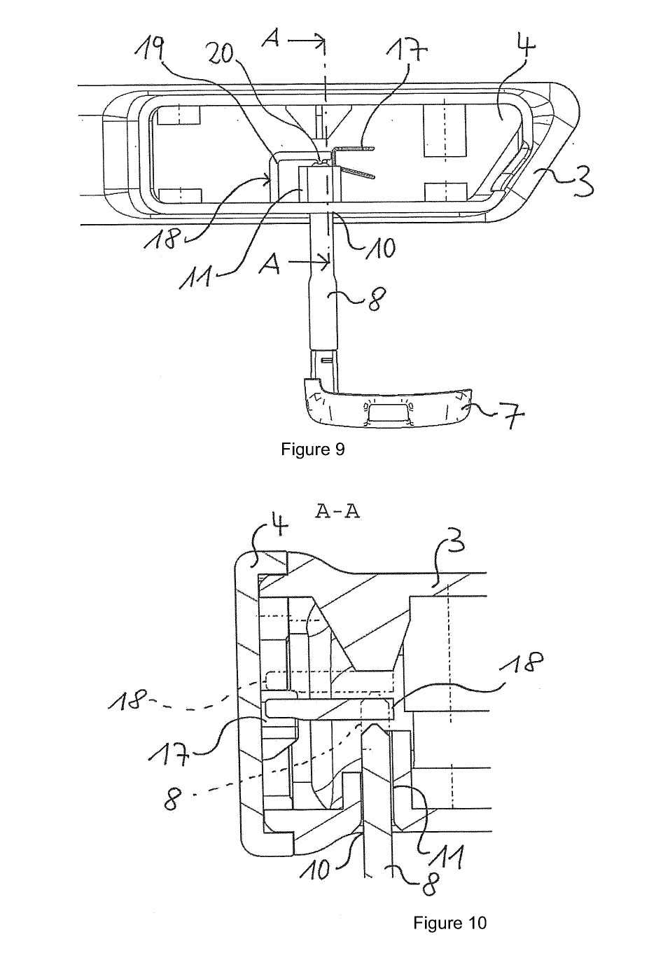

Disassembly is discussed below in more detail based on FIGS. 9 to 12. The uninterrupted disassembly of the trim 4 in the horizontal direction Q can be performed only through loosening the second interlocking connection and if the handle unit 2 is in an intermediate position or in the operating position.

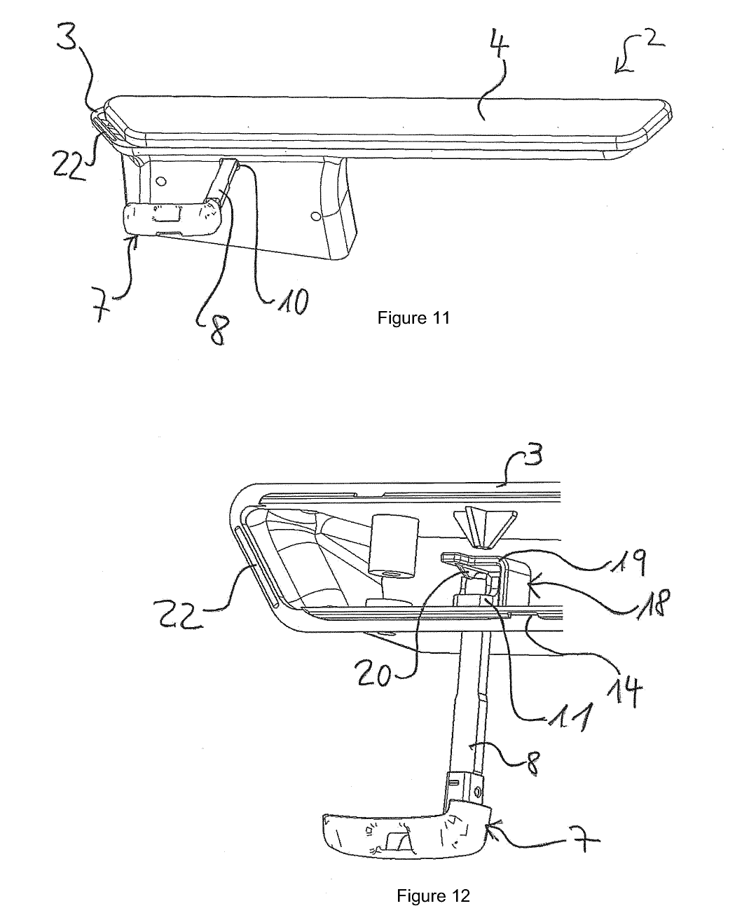

That is why, initially, the handle unit 2 is advantageously moved into the operating position in order to make the opening 10 accessible for the worker. For disassembly an object is necessary that must be inserted through the opening 10 into the handle housing 3. The shaft of the key 8 of the emergency key 7 is suited for this because the dimensions of the shaft of the key 8 match the dimensions of the opening 10 and the guide channel 11 in order essentially to insert the shaft of the key 8 into the handle housing 3 without play. As shown in FIG. 9, the shaft of the key 8 is inserted into the handle housing 3. In doing so, the shaft of the key 8 is located in the opening 10 and in the guide channel 11, and touches the tongue protruding element 20 of the clip 18. The L-shaped tongue 19 arranged in the handle housing 3 is in contact with the protruding element 17. The user presses the shaft of the key 8 in the direction of the tongue protruding element 20. It can be realized from FIG. 10, which presents a section A-A of FIG. 9, how the shaft of the key 8 is inserted into the guide channel 11. The state is shown in FIG. 9 by the dotted line, in which the shaft of the key 8 has pushed the elastic tongue 19 away from the protruding element 7. By this movement the protruding element 17 is released, and the second interlocking connection between the trim 4 in the handle housing 3 is removed. The trim 4 can then be moved in the longitudinal direction L to the handle housing 3, as shown in FIG. 11. In doing so, once again a somewhat increased use of power must be used because the third the locking connection must be removed in which the rib element 22 must be loosened from the groove 21. During movement of the trim 4, the first interlocking connection is also removed because the locking element 22 is pulled out of the locking section 13. When the locking element 22 has been completely moved out of the locking section 13, the trim 4 can again be removed in the horizontal direction Q of the handle housing 3. As one may see in FIG. 12, the trim 4 has been removed from the handle housing 3. The elastic clip 18, in particular the tongue 19, has moved back into its original position because the shaft of the key 8 has been drawn out of the handle housing, again.

After the shaft of the key 8 has been completely removed from the handle housing 3, the assembly of the trim 4 can occur.

Other alternative embodiments of the door handle module 1 are possible, so that as a result the function component can also be designed as a camera unit, or as a light sensor, or as front area lighting, wherein the front area lighting is activated only in the operating position to illuminate the front area.

As already mentioned above, a recess may also be arranged in the handle housing 3 instead of an opening 10.

In addition, it is conceivable that the opening 10 or recess can be provided with a rubber lip that closes the opening 10 or recess, and that opens only when pulling through the object, in particular the shaft of the key 8. The rubber lip thereby serves as protection against moisture and dirt, which otherwise might penetrate into the handle housing 3 through the opening 10 or the recess.

1. A door handle module for a motor vehicle, the door handle module having at least a handle unit comprising a handle housing and a trim, wherein the handle housing is designed to be movable relative to a door of a motor vehicle between a resting position and an operating position, and the trim is arranged at least substantially flush with the outside of the door in the resting position, wherein the trim can be connected to the handle housing by at least two interlocking connections,
wherein, during assembly of the trim, a first interlocking connection, which secures the trim to the handle housing in a horizontal direction, and a second interlocking connection, which secures the trim to the handle housing in a longitudinal direction, is simultaneously manufacturable, wherein an uninterrupted disassembly of the trim in the horizontal direction can be accomplished only by loosening the second interlocking connection, wherein loosening of the first interlocking connection can only be accomplished after loosening the second interlocking connection.

2. The door handle module according to claim 1, wherein the door handle module includes a support.

3. The door handle module according to claim 1, wherein the door handle module includes a support, and the handle unit has a recess or an opening, in which an object, in particular a shaft of a key, can be inserted in order to loosen the second interlocking connection between the trim and the handle housing.

4. The door handle module according to claim 3, or wherein the opening or recess is arranged on the handle housing.

5. The door handle module according to claim 3, wherein the opening or recess opens into a guide channel, which is arranged at least partially within the handle housing.

6. The door handle module according to claim 3, wherein the recess or opening is arranged inside the support invisible from outside in the resting position.

7. The door handle module according to claim 1, wherein loosening the second interlocking connection between the trim and the handle housing can be accomplished only in the operating position and/or in an intermediate position, in which the handle unit lies between the resting position and the operating position.

8. The door handle module according to claim 1, wherein the first interlocking connection between the trim and the handle housing is designed with at least one locking connection.

9. The door handle module according to claim 8, wherein the locking connection is designed by at least one locking element arranged on the trim and at least one counterlocking element arranged on the handle housing, wherein, in an assembled state of the trim, the locking element is arranged behind the counterlocking element in order to prevent any horizontal movement of the trim.

10. The door handle module according to claim 8, wherein the locking connection is designed as an undercut connection, wherein, in an assembled state of the trim, a locking element arranged on the trim is connected with an undercut side recess arranged on the handle housing, in particular in an L shape.

11. The door handle module according to claim 10, wherein at least one counterlocking element is arranged on the handle housing, and wherein the undercut side recess, in particular a wall partition of the undercut side recess, is formed at least partially by the counterlocking element.

12. The door handle module according to claim 1, wherein the second interlocking connection between the trim and the handle housing is designed with at least one clip connection.

13. The door handle module according to claim 12, wherein the handle unit has a recess or opening, and wherein the recess or opening is arranged in an area of the clip connection.

14. The door handle module according to claim 12, wherein the clip connection is designed to be on a protruding element arranged on the trim and an elastic movable clip is arranged on the handle housing, wherein, in an assembled state of the trim on the handle housing, the clip contacts the protruding element in order to secure the trim in the longitudinal direction.

15. The door handle module according to claim 14, wherein the elastic movable clip is designed as an L-shaped tongue.

16. The door handle module according to claim 15, wherein the handle unit has a recess or opening, and wherein the L-shaped tongue is arranged as a tongue protruding element, which is arranged opposite the opening or the recess, in particular opposite a guide channel.

17. The door handle module according to claim 14, wherein upon insertion of an object, the elastic clip is designed to be movable in order to loosen the second interlocking connection, in particular contact between the protruding element and the clip.

18. The door handle module according to claim 1, wherein the trim and the handle housing are connected by a third interlocking connection, wherein the third interlocking connection is designed as a rib-groove connection, which is designed with at least one groove on the trim and with at least one rib element arranged on the handle housing, or which is designed with at least one rib element arranged on the trim and with at least one groove arranged on the handle housing.

19. The door handle module according to claim 18, wherein during assembly of the trim, the first interlocking connection and the third interlocking connection, which also secures the trim in the longitudinal direction, can be created simultaneously between the handle housing and the trim.

20. The door handle module according to claim 18, wherein an undisturbed disassembly of the trim can be performed only by loosening the second interlocking connection, wherein loosening of the third interlocking connection is possible only after loosening the second interlocking connection.

21. The door handle module according to claim 1, wherein the door handle module includes a support, and wherein a function component, in particular a locking cylinder, is arranged inside the support and behind the handle unit, in particular behind the handle housing.
